(19) United States
(12) Patent Application Publication
(10) Pub. No.: US 2005/0258702 A1
(43) Pub. Date: Nov. 24, 2005

(54) Multiple winding coil shapes for increased slot fill

(76) Inventor: Paul G. Michaels, St. Louis, MO (US)

Correspondence Address: HARNESS, DICKEY & PIERCE, P.L.C., P.O. BOX 828, BLOOMFIELD HILLS, MI, 48303, US

(21) Appl. No.: 10/850,598

(22) Filed: May 19, 2004

(51) Int. Cl. H02K 1/00; H02K 3/00

(52) U.S. Cl. 310/179; 310/180; 310/254; 310/184

(57) ABSTRACT

A stator of an electric machine includes stator teeth. First windings are wound around first stator teeth and define a first cross section having a width that is narrower at a first radial edge of said stator teeth and that is wider at a second radial edge of said stator teeth. Second windings are wound around second stator teeth and define a second cross section. The first and second windings have an interleaved relationship.

### FIELD OF THE INVENTION

The present invention relates to stators of electric machines, and more particularly to multiple winding coil shapes for stators of electric machines.

### BACKGROUND OF THE INVENTION

Reluctance electric machines, such as motors and generators, typically include a stator that is mounted inside a machine housing and a rotor that rotates relative to the stator. Reluctance electric machines produce torque as a result of the rotor tending to rotate to a position that minimizes the reluctance of the magnetic circuit (and maximizes the inductance of the stator windings). The reluctance of the rotor is minimized when a pair of diametrically-opposed rotor poles are aligned with a pair of energized and diametrically-opposed stator poles. In synchronous reluctance electric machines, the windings are energized at a controlled frequency. In switched reluctance electric machines, the angular position of the rotor is detected. A drive circuit energizes the stator windings as a function of the sensed rotor position.

Conventional switched reluctance electric machines generally include a stator with a solid stator core and/or a laminated stator with a plurality of circular stator laminations. The laminations are usually punched from a magnetically conducting material and are stacked together. In inside-rotor electric machines, the stator plates define salient stator teeth that project radially inward and inter-tooth slots that are defined between adjacent stator teeth. Wire is wound to form windings about the stator teeth. The rotor rotates inside of the stator.

There are several conventional methods for placing the winding wire on the stator of a switched reluctance electric machine. One conventional method is referred to as transfer winding. Transfer winding involves transferring pre-wound windings onto the stator teeth. In some instances however, interference between adjacent winding may inhibit the assembly process. Transfer winding can achieve slot fill up to around 65% when the stator is not segmented. Another conventional winding method includes needle winding. Needle winding employs a needle that winds the wire directly on the stator teeth. The needle, however, takes up some of the stator slot area and generally reduces slot fill to approximately 50% when the stator is not segmented.

As can be appreciated, increasing the number of winding turns and the slot fill increases the torque density of the electric machine. The number of winding turns, however, is limited by the proximity of adjacent windings. More particularly, because the stator teeth extend radially, adjacent stator teeth are closer together at a radially-inner end. Therefore, the narrower end limits the number of winding turns at the wider or radially-outer end.

### SUMMARY OF THE INVENTION

Accordingly, the present invention provides a stator of an electric machine. The stator includes stator teeth. First windings are wound around first stator teeth and define a first cross section having a width that is narrower at a first radial edge of said stator teeth and that is wider at a second radial edge of said stator teeth. Second windings are wound around second stator teeth and define a second cross section. The first and second windings have an interleaved relationship.

In one feature, the second cross section is rectangular-shaped. The first cross section is trapezoidal-shaped.

In another feature, the first cross section is trapezoidal-shaped. The second cross section is trapezoidal-shaped that is inverted relative to the first cross section.

In another feature, a width of the second cross section remains constant along a length of the stator teeth.

In still another feature, the width of the first cross section is narrower at a radial inner edge of the stator teeth and is wider at a radial outer edge of the stator teeth.

In yet another feature, the width of the second cross section is wider at a radial inner edge of the stator teeth and is narrower at a radial outer edge of the stator teeth.

In still another feature, the first windings are assembled onto the first stator teeth before the second windings are assembled onto the second stator teeth.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a cross-sectional view of an electric machine having a stator that includes multiple winding coil shapes according to the present invention; and

FIG. 2 is a cross-sectional view of the electric machine having a stator that includes alternative multiple winding coil shapes according to the present invention.

### DETAILED DESCRIPTION OF THE PREFERRED EMBODIMENTS

The following description of the preferred embodiments is merely exemplary in nature and is in no way intended to limit the invention, its application, or uses. For purposes of clarity, the same reference numbers will be used in the drawings to identify similar elements.

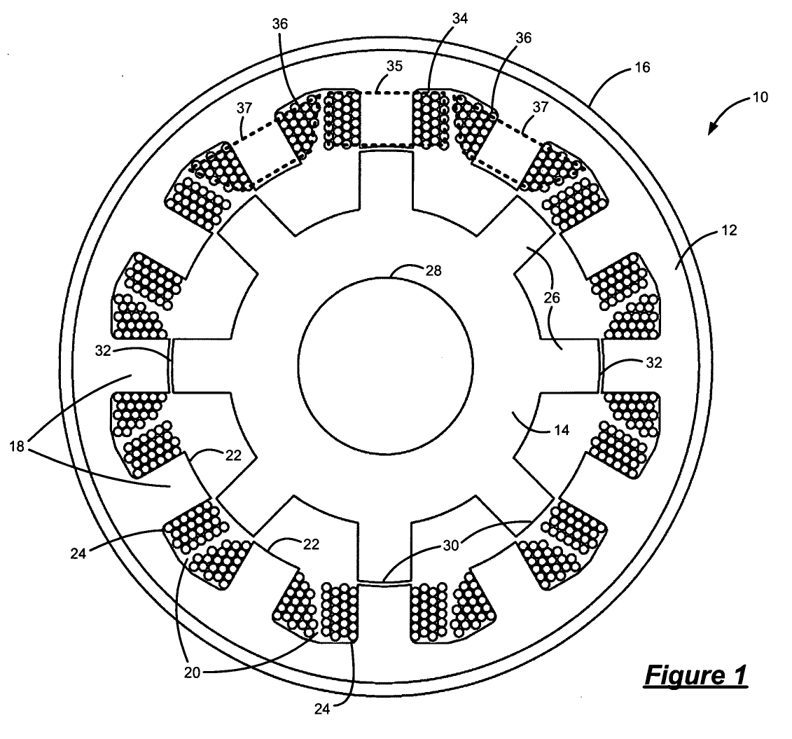

Referring now to FIG. 1, an exemplary electric machine 10 is illustrated and includes a stator 12 and a rotor 14. The stator 12 is attached to a housing 16 and the rotor 14 rotates relative to the stator 12. The stator 12 includes a plurality of radially extending stator teeth 18 and slots 20 separating adjacent stator teeth 18. Each stator tooth 18 has an arcuate inner edge 22 and a base 24. The stator is preferably defined by a plurality of stator plates or laminations (not shown) that are stacked together. The stator plates are die cut from thin sheets of magnetically conductive material that are stacked and press fit together. Alternatively, the stator can be solid rather than including a plurality of laminations.

The rotor 14 includes a plurality of radially extending rotor teeth 26. A circular bore 28 is formed in the rotor 14. A rotor shaft (not shown) is received by and fixed to the circular bore 28 of the rotor 14. Each rotor tooth 26 has an arcuate outer edge 30. An air gap 32 is defined between the arcuate outer edges 30 of the rotor teeth 26 and the arcuate inner edges 22 of the stator teeth 18. In the particular embodiment shown, the rotor 14 has eight equally-spaced rotor teeth 26 and the stator 12 has twelve equally-spaced stator teeth 18. Other rotor teeth and stator teeth combinations are also contemplated.

Windings are wound about the individual stator teeth 18 and are electrically connected to windings on other stator teeth 18. A first set of windings 34 wound around some of the stator teeth 18 have a first cross section. The first cross section includes an approximately equal number of turns along the stator tooth 18 and is generally rectangular-shaped as illustrated by dotted lines 35. A second set of windings 36 are formed around others of the stator teeth 18 and have a second cross section. The second cross section includes an increasing number of turns along the stator tooth 18 and is generally trapezoidal-shaped as illustrated by dotted lines 37. The number of turns increases from the radially inner arcuate edge 22 to the radially outer base 24 of the stator tooth 18. The first and second sets of windings 34, 36 are interleaved around the teeth of the stator 12. More particularly, first windings 34 having the cross section are disposed between adjacent second windings 36 having the second cross section. Likewise, the second windings 36 having the second cross section are disposed between adjacent first windings 34 having the first cross section.

The interleaved placement of the first and second sets of windings 34,36 enables improved assembly of the electric machine 10. When using the transfer winding method, the second windings 36 can be assembled onto every other stator tooth 18. The first windings 34 are assembled onto the adjacent stator teeth 18. Because the first and second windings 34,36 include different cross sections, winding interference is reduced and the ease of assembly of the electric machine 10 is increased. Additionally, the second cross section includes more windings toward the base 24 of the stator tooth 18. As a result, the slot fill between adjacent stator teeth 18 is increased.

Although multiple cross sections are implemented, the electromagnetic characteristics of the electric machine 10 are symmetric. More particularly, diametrically opposed stator teeth 18 have windings with the same cross section. For example, stator teeth 18 with first windings 34 are diametrically opposed to stator teeth 18 with first windings 34. Similarly, stator teeth 18 with second windings 36 are diametrically opposed to stator teeth 18 with second windings 36.

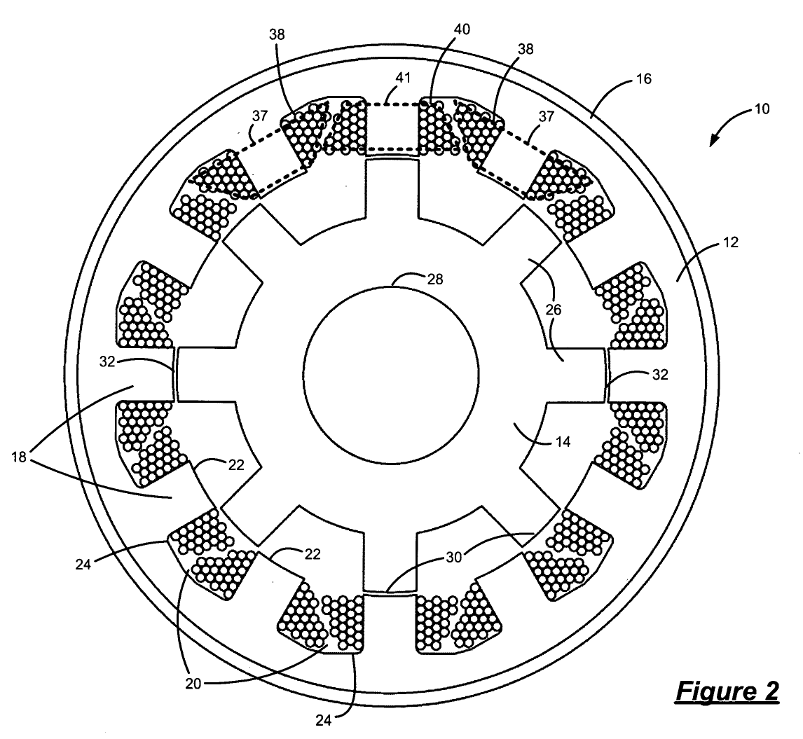

Referring now to FIG. 2, alternative winding sets are illustrated. The alternative winding sets include third windings 38 interleaved between fourth windings 40 on the stator teeth 18. The third windings 38 have a third cross section that is similar to the second cross section of the second windings 36. The fourth windings 40 include a fourth cross section that mirrors the third cross section. More particularly, the third cross section includes an increasing number of turns along the stator tooth 18. The number of turns increases from the radially inner arcuate edge 22 to the radially outer base 24 of the stator tooth 18 to form a generally trapezoidal profile. The fourth cross section includes a decreasing number of turns along the stator tooth 18 so the fourth cross section is trapezoidal-shaped as illustrated by dotted lines 41. The number of turns decreases from the radially inner arcuate edge 22 to the radially outer base 24 of the stator tooth 18 profile that is inverted as compared to the generally trapezoidal profile of the third windings 38.

While the present invention is described in conjunction with switched reluctance type electric machines, the present invention may also be implemented with other types of electric machines. Such electric machines include, but are not limited to, brushless permanent magnet electric machines. It is anticipated that the multiple shape windings of the present invention can be implemented in any type of electric machine having adjacent windings disposed on teeth that extend radially inward.

As can be appreciated from the foregoing, the multiple shape windings according to the invention improves the torque density of the electric machine by allowing the stator to be precisely wound with increased slot fill. More particularly, implementation of the multiple shape windings of the present invention increases the windable area between the stator teeth by up to 23%. That is to say, the multiple shape windings can account for 23% more of the area between adjacent stator teeth than traditional winding schemes. As a result, the torque output for the electric machine can be increased. Alternately, the outer dimensions of the electric machine can be reduced for a given torque output. Further, the multiple shape windings of the present invention simplify the manufacturing process. More particularly, in the case of transfer winding, assembly of adjacent windings is more easily achieved using the multiple shape windings of the present invention.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

1. A stator of an electric machine, comprising:
a plurality of stator teeth;
first windings that are wound around first stator teeth and that define a first cross section having a width that is narrower at a first radial edge of said stator teeth and that is wider at a second radial edge of said stator teeth; and
second windings that are wound around second stator teeth and that define a second cross section, wherein said second cross section is different than said first cross section and said first and second windings have an interleaved relationship.

2. The stator of claim 1 wherein said second cross section is rectangular-shaped.

3. The stator of claim 1 wherein said first cross section is trapezoidal-shaped.

4. The stator of claim 3 wherein said second cross section is trapezoidal-shaped and is inverted relative to said first cross section.

5. The stator of claim 1 wherein a width of said second cross section remains constant along a length of said stator teeth.

6. The stator claim 1 wherein said width of said first cross section is narrower at a radial inner edge of said stator teeth and is wider at a radial outer edge of said stator teeth.

7. The stator of claim 6 wherein said width of said second cross section is wider at a radial inner edge of said stator teeth and is narrower at a radial outer edge of said stator teeth.

8. The stator of claim 1 wherein said first windings are assembled onto said first stator teeth before said second windings are assembled onto said second stator teeth.

9. An electric machine, comprising:
a stator defining a plurality of stator teeth;
first windings that are wound around first stator teeth and that define a first cross section having a width that is narrower at a first radial edge of said stator teeth and that is wider at a second radial edge of said stator teeth; and
second windings that are wound around second stator teeth and that define a second cross section;
wherein said first and second windings have an interleaved relationship.

10. The electric machine of claim 9 wherein said second cross section is rectangular-shaped.

11. The electric machine of claim 10 wherein said first cross section is trapezoidal-shaped.

12. The electric machine of claim 9 wherein said second cross section is trapezoidal-shaped.

13. The electric machine of claim 12 wherein said second cross section is trapezoidal-shaped and is inverted relative to said first cross section.

14. The electric machine of claim 9 wherein a width of said second cross section remains constant along a length of said stator teeth.

15. The electric machine claim 9 wherein said width of said first cross section is narrower at a radial inner edge of said stator teeth and is wider at a radial outer edge of said stator teeth.

16. The electric machine of claim 15 wherein said width of said second cross section is wider at a radial inner edge of said stator teeth and is narrower at a radial outer edge of said stator teeth.

17. The electric machine of claim 9 wherein said first windings are assembled onto said first stator teeth before said second windings are assembled onto said second stator teeth.

18. A stator of an electric machine, comprising:
a plurality of stator teeth including first and second stator teeth and a third stator tooth disposed between said first and second stator teeth;
a first winding that defines a first cross section having a width that is narrower at a first radial edge of said stator teeth and that is wider at a second radial edge of said stator teeth; and
second windings that each define a second cross section and that are respectively supported on said first and second stator teeth, wherein said first winding is supported on said third stator tooth.

19. The stator of claim 18 wherein said first winding is assembled onto said third stator tooth prior to assembly of said second windings onto said first and second stator teeth.

20. The stator of claim 18 wherein said second cross section is rectangular-shaped.

21. The stator of claim 18 wherein said first cross section is trapezoidal-shaped.

22. The stator of claim 21 wherein said second cross section is trapezoidal-shaped that is inverted relative to said first cross section.

23. The stator of claim 18 wherein a width of said second cross section remains constant along a length of said first and second stator teeth.

24. The stator claim 18 wherein said width of said first cross section is narrower at a radial inner edge of said stator teeth and is wider at a radial outer edge of said stator teeth.

25. The stator of claim 18 wherein said width of said second cross section is wider at a radial inner edge of said stator teeth and is narrower at a radial outer edge of said stator teeth.

26. A method of assembling an electric machine, comprising:
assembling a first winding defining a first cross section having a width that is narrower at a first radial edge of said stator teeth and that is wider at a second radial edge of said stator teeth onto a stator tooth of a stator; and
assembling a second winding defining a second cross section onto an adjacent stator tooth of said stator, wherein said first cross section is different than said second cross section.

27. The method of claim 26 further comprising winding said first winding prior to said step of assembling said first winding onto said stator tooth.

28. The method of claim 26 further comprising winding said second winding prior to said step of assembling said second winding onto said adjacent stator tooth.

29. The method of claim 26 wherein said second cross section is rectangular-shaped.

30. The method of claim 26 wherein said first cross section is trapezoidal-shaped.

31. The method of claim 30 wherein said second cross section is trapezoidal-shaped that is inverted relative to said first cross section.

32. The method of claim 26 wherein a width of said second cross section remains constant along a length of said stator teeth.

33. The method claim 26 wherein said width of said first cross section is narrower at a radial inner edge of said stator teeth and is wider at a radial outer edge of said stator teeth.

34. The method of claim 26 wherein said width of said second cross section is wider at a radial inner edge of said stator teeth and is narrower at a radial outer edge of said stator teeth.

35. The method of claim 26 wherein said step of assembling said first winding occurs before said step of winding said second winding.
